(19) United States
(12) Patent Application Publication
(10) Pub. No.: US 2018/0236277 A1
(43) Pub. Date: Aug. 23, 2018

(54) FIRE-STOPPING SUSPENSION APPARATUS AND METHOD OF USING THE SAME TO STOP THE SPREAD OF FIRE

(71) Applicants: Vicki-Fen CHOU, Taoyuan City (TW); Philip TRINH, Taoyuan City (TW); Christine TRINH, Taoyuan City (TW)

(72) Inventors: Song CHOU, Taoyuan City (TW); Vicki-Fen CHOU, Taoyuan City (TW); Philip TRINH, Taoyuan City (TW); Christine TRINH, Taoyuan City (TW)

(21) Appl. No.: 15/439,065

(22) Filed: Feb. 22, 2017

(51) Int. Cl. A62C 2/04; A62C 3/02; A62C 99/00

(52) U.S. Cl. CPC A62C 2/04; A62C 99/0045; A62C 3/0257

(57) ABSTRACT

The present invention provides a fire-stopping suspension comprising a top suspension device and a bottom suspension device. The top suspension device comprises a first transmission mechanism, a plurality of shafts having fire-retardant fabrics thereon, and a top suspension support frame, wherein the first transmission mechanism drives the shafts to roll out or roll back the fire-retardant fabrics. The bottom suspension device comprises a second transmission mechanism, a plurality of first cutter shafts, and a bottom suspension support frame, wherein the bottom suspension support frame is suspended at lower ends of the fire-retardant fabrics, and the second transmission mechanism drives the first cutter shafts so that objects under the bottom suspension device can be easily cut and chopped by the first cutter shafts. The present invention also provides a method of using said fire-stopping suspension apparatus to stop the spread of fire.

### BACKGROUND OF THE INVENTION

### Field of the Invention

The present invention relates to a fire-stopping suspension apparatus and a method of using said apparatus to stop the spread of fire. More particularly, the present invention relates to a fire-stopping suspension apparatus for stopping the spread of a forest fire and a method of using said apparatus.

### Description of the Prior Art

Across the world, large-scale forest fires or wildfires are now more likely to occur as climate change becomes more severe, and sometimes they are exacerbated by other natural or human factors. Forest fires are particularly prevalent in fall and winter. In the past 20 years, large wildfires like the 1987 Daxing' anling wildfire in China, the 2010 Russian wildfires and the 2010 California wildfires, caused enormous damage to property, human life and natural environment because the burning was long-lasting and affected a huge area each time. As forest fires tend to occur in windy mountainous areas where firefighters are hard to reach, stopping forest fires has always been a great challenge. Even if firefighters have managed to reach the scene, it is still hard to suppress the fire burning in 10-meter-high trees with existing firefighting equipment.

It is not uncommon to see news reports about forest fires or bushfires. As a forest generally covers a large area, and every piece of land within the forest could become a trigger to induce another fire, if forest fires cannot be suppressed at an early stage, they may lead to disastrous outcomes. The 2016 Fort McMurray wildfire in Canada is a recent example. The wildfire started about 15 km southwest of the city of Fort McMurray in Alberta, Canada on May 1, 2016. It spread rapidly and swept through the city, destroying more than 2,400 homes and buildings and forcing the largest wildfire evacuation in Albertan history. The wildfire continued to spread across northern Alberta and crossed into Saskatchewan on May 19, spreading across nearly 590,000 hectares (1,500,000 acres) before being declared under control on Jul. 5, 2016. The wildfire hampered Canada's oil-sands operations and was the costliest natural disaster in Canadian history. It is evident that forest fires can bring disastrous outcomes.

Various firefighting equipments have been developed to solve problems related to forest fires. Most of the existing firefighting technologies focus on on-the-ground firefighting equipments or aerial firefighting techniques that utilize helicopters to spray water or firefighting foam. However, water or foam spray might evaporate or be blown away easily by wind, achieving little success in fighting forest fires.

### SUMMARY OF THE INVENTION

An object of the present invention is to provide a fire-stopping suspension apparatus that can prevent a forest fire from spreading further, and a method of using said apparatus to prevent the spread of fire.

Another object of the present invention is to provide a fire-stopping suspension apparatus that can effectively block the spread of a forest fire, and a method of using said apparatus to stop the spread of fire.

To achieve the above objects, a fire-stopping suspension apparatus according to the present invention comprises a top suspension device and a bottom suspension device. The top suspension device comprises a first transmission mechanism, a plurality of shafts having fire-retardant fabrics thereon, and a top suspension support frame, wherein the shafts and the first transmission mechanism are mounted to the top suspension support frame, and the first transmission mechanism drives the shafts to roll out or roll back the fire-retardant fabrics. The bottom suspension device comprises a second transmission mechanism, a plurality of first cutter shafts, and a bottom suspension support frame, wherein the first cutter shafts and the second transmission mechanism are mounted to the bottom suspension support frame which is suspended at lower ends of the fire-retardant fabrics, and the second transmission mechanism drives the first cutter shafts so that objects under the bottom suspension device can be easily cut and chopped by the first cutter shafts.

To achieve the above objects, a method of using said fire-stopping suspension apparatus to stop the spread of fire comprises the following steps: determining a wind direction of a fire scene; based on the scale of the fire scene, suspending a plurality of fire-stopping suspension apparatuses respectively, wherein an axial direction of each fire-stopping suspension apparatus and the wind direction form an acute angle, and the plurality of fire-stopping suspension apparatuses are suspended and arranged along a path of the wind; and making the top suspension device of each fire-stopping suspension apparatus to roll out the fire-retardant fabrics and the bottom suspension device of each fire-stopping suspension apparatus to cut and chop underneath objects; and making the fire-retardant fabrics on the fire-stopping suspension apparatuses to form a fire-stopping surface, which creates a separation between burning and unburned parts in the fire scene.

### BRIEF DESCRIPTION OF THE DRAWINGS

FIG. 1 is a schematic view of a fire-stopping suspension apparatus according to the present invention.

FIG. 2 is a schematic view of the bottom suspension device of the fire-stopping suspension apparatus.

FIG. 3 is a schematic view showing a single cutter shaft and a pair of cutters according to the present invention.

FIG. 4 is a schematic view showing the use of the fire-stopping suspension apparatuses according to the present invention.

FIG. 5 is a flow chart showing a method of using the fire-stopping suspension apparatus of the present invention to stop the spread of fire.

### DETAILED DESCRIPTION OF THE PREFERRED EMBODIMENTS

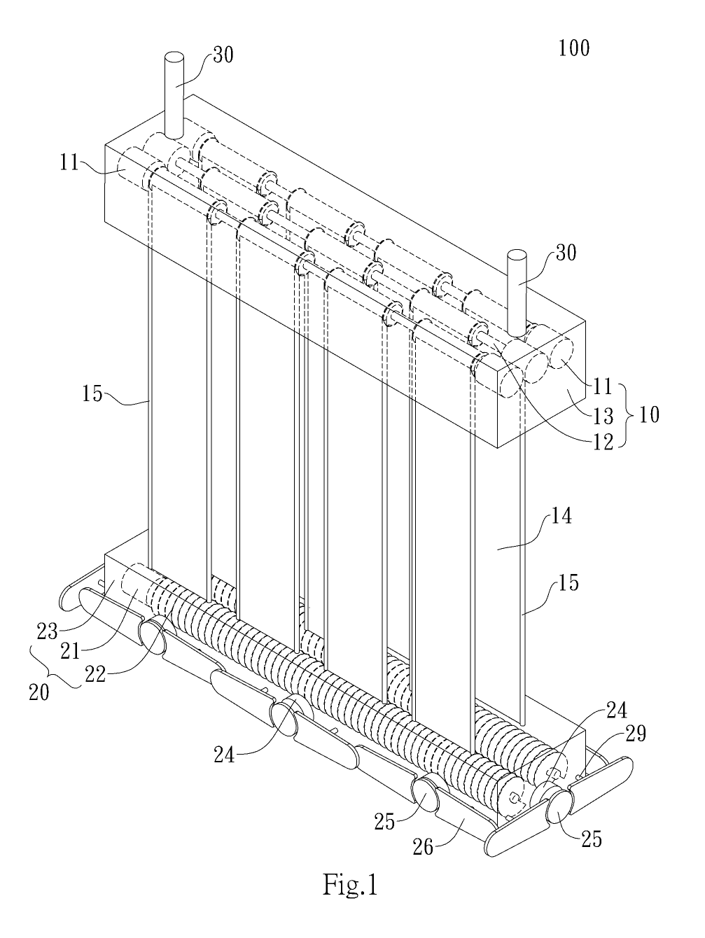

FIG. 1 shows a fire-stopping suspension apparatus 100 comprising a top suspension device 10 and a bottom suspension device 20. The top suspension device 10 includes a first transmission mechanism 11, a plurality of shafts 12 having fire-retardant fabrics 14 on them, and a top suspension support frame 13, wherein the shafts 12 and the first transmission mechanism 11 are mounted to the top suspension support frame 13, and the first transmission mechanism 11 drives the shafts 12 to roll out or roll back the fire-retardant fabrics 14. The bottom suspension device 20 includes a second transmission mechanism 21, a plurality of first cutter shafts 22, and a bottom suspension support frame 23. The first cutter shafts 22 and the second transmission mechanism 21 are mounted to the bottom suspension support frame 23, which is suspended at the lower end of the fire-retardant fabrics 14. The second transmission mechanism 21 drives the first cutter shafts 22, so that objects under the bottom suspension device 20 can be easily cut and chopped by the first cutter shafts 22.

FIG. 1 shows that the fire-stopping suspension apparatus 100 according to the present invention further comprises suspension arms 30 on the top suspension support frame 13. The suspension arms 30 are used for hanging the fire-stopping suspension apparatus 100 on a helicopter (not shown), so that the fire-stopping suspension apparatus 100 can be suspended from a helicopter used in a fire-fighting task which aims to create a separation between burning and unburned parts in a fire scene and to further extinguish the fire. In an embodiment of the present invention, each of the fire-retardant fabrics 14 has a width of 50 m and a length of 200 m. The fire-retardant fabrics 14 disposed on each shaft 12 are spaced apart from one another; moreover, as shown in FIG. 1, the fire-retardant fabrics 14 on every two adjacent shafts are arranged alternately to reduce wind speed. In addition, each fire-retardant fabric 14 has at least two holes (not shown) at opposite sides thereof, and a steel wire rope 15 passes through each hole to connect the top suspension device 10 and the bottom suspension device 20 so as to hold the weight of the bottom suspension device 20.

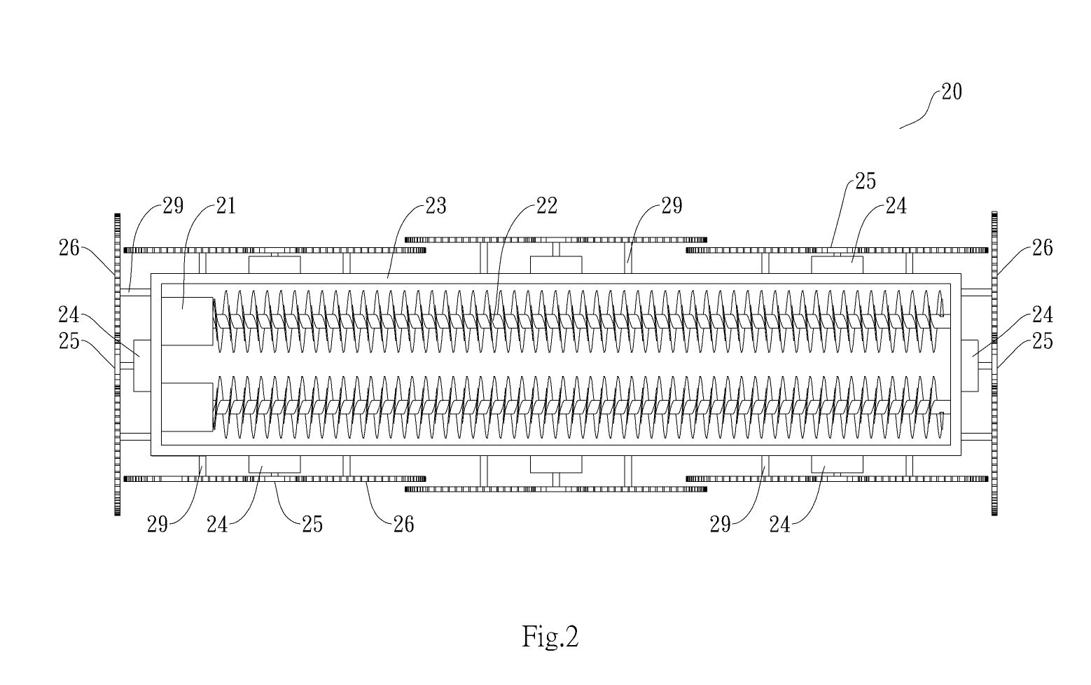

FIG. 2 is a schematic view of the bottom suspension device of the fire-stopping suspension apparatus. The bottom suspension device 20 of the fire-stopping suspension apparatus 100 further comprises a plurality of third transmission mechanisms 24 and a plurality of second cutter shafts 25. A pair of cutters 26 is provided at two opposite sides of each second cutter shaft 25. The third transmission mechanisms 24, second cutter shafts 25 and the cutters 26 are arranged at the outer edge of the bottom suspension support frame 23. The third transmission mechanisms 24 drive the second cutter shafts 25, which then cause the cutters 26 to move accordingly, so that the cutters 26 can easily cut and chop objects around the bottom suspension device 20.

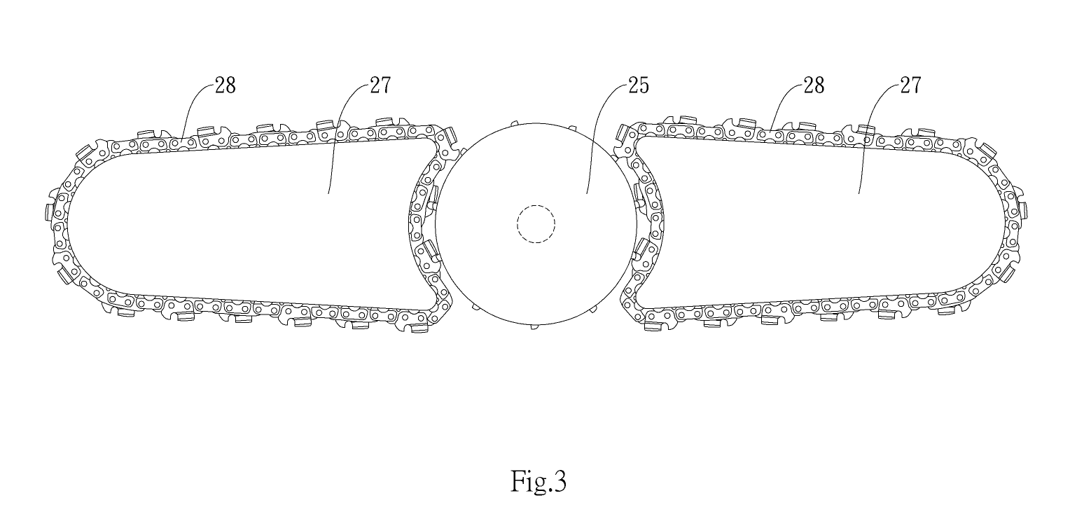

Please refer to both FIG. 2 and FIG. 3. FIG. 3 is a schematic view showing a single cutter shaft and a pair of cutters according to the present invention. In this embodiment, each cutter 26 comprises a guide plate 27 and a chain 28. The guide plate 27 is secured to the outer edge of the bottom suspension support frame 23 by means of a supporting portion 29. The second cutter shaft 25 is a sprocket whose teeth fit into and engage the chains 28. As such, when each third transmission mechanism 24 drives a corresponding second cutter shaft 25, that second cutter shaft 25 then causes the chains 28 at two opposite sides to roll accordingly. Consequently, the cutters 26 are also rolling simultaneously to cut and chop nearby objects.

Further, in this embodiment, the bottom suspension support frame 23 is in the shape of a cuboid. Each of two long opposite sides of the bottom suspension support frame 23 is provided with three sets of a third transmission mechanism 24, a second cutter shaft 25, and a pair of cutters 26. In contrast, each of two short opposite sides is provided with one set of a third transmission mechanism 24, a second cutter shaft 25, and a pair of cutters 26. Every two adjacent second cutter shafts 25 are arranged in a manner so that they do not align, and therefore, each pair of cutters 26 connected to a second cutter shaft 25 does not align with another pair of cutters 26. Moreover, in this embodiment, each pair of cutters 26 connected to a second cutter shaft 25 overlaps with another pair of cutters 26. In this way, when a pair of cutters 26 is rolling and chopping objects, the objects are not likely to get stuck between two adjacent pairs of cutters 26. In addition, the only one pair of cutters 26 at each of the two short opposite sides has a length which is longer than the width of the bottom suspension support frame 23, and extends beyond the cutters at the long opposite sides. Similarly, this arrangement can prevent objects from getting stuck between two adjacent pair of cutters while they are rolling and chopping objects. As such, for the fire-stopping suspension apparatus 100, the specific arrangement of the third transmission mechanisms 24, the second cutter shafts 25 and the cutters 26 allows the bottom suspension device 20 to operate in a larger area to cut and chop objects around it; also, objects can be cut and chopped more completely by the bottom suspension device 20.

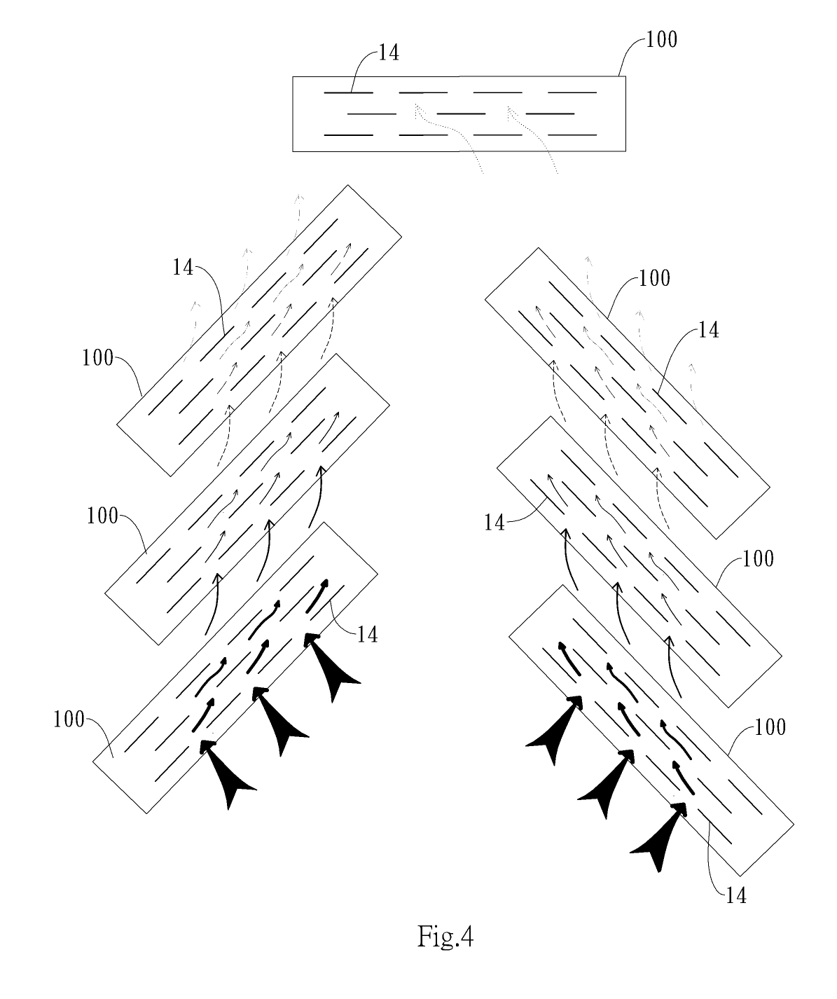

Please refer to FIG. 4 and also to FIGS. 1 and 2 as needed. FIG. 4 is a schematic view showing the use of the fire-stopping suspension apparatuses according to the present invention. When a forest fire occurs and multiple helicopters are ready to be sent to the fire scene, the fire-stopping suspension apparatuses 100 of the present invention can be hung on the helicopters and sent together to the fire scene. The amount of fire-stopping suspension apparatuses 100 to be used in the fire scene is based on the scale of the fire scene. When the helicopters with fire-stopping suspension apparatuses 100 reach the fire scene, they can be used to enclose burning areas depending on the spread and severity of the forest fire. Thereafter, the first transmission mechanism 11 of each fire-stopping suspension apparatus 100 can drive the plurality of shafts 12 which have fire-retardant fabrics 14 on them. The fire-retardant fabrics 14 on each fire-stopping suspension apparatus 100 can be rolled down slowly, and at the same time, the second transmission mechanism 21 can drive the plurality of first cutter shafts 22 to cut and chop tree branches or trunks under the bottom suspension device 20. Meanwhile, the plurality of third transmission mechanisms 24 can drive the respective second cutter shafts 25 to cut and chop tree branches or trunks around the bottom suspension device 20. The fire-retardant fabrics 14 can stop the spread of burning fires by forming a fire-stopping surface that creates a separation between burning and unburned parts in the fire scene. Moreover, each fire-stopping suspension apparatus 100 is arranged so that its axial direction and the wind direction form an acute angle. As such, when the wind flows along the direction of the fire-stopping suspension apparatuses 100 that have been put to enclose the burning fire, the wind has to flow through several rows of fire-retardant fabrics 14 arranged alternately on each fire-stopping suspension apparatus 100 and will then become weaker and weaker. In FIG. 4, the wind directions are indicated by the arrows. It can be seen that the wind flowing through the first fire-stopping suspension apparatus 100 is indicated by the heavy, bold arrows. When the wind comes in contact with the first row of fire-retardant fabrics 14 on the first fire-stopping suspension apparatus 100, the wind is obstructed a bit and then continues to flow to the next row of fire-retardant fabrics 14. Therefore, after flowing through the rows of fire-retardant fabrics on the plurality of fire-stopping suspension apparatuses 100, the wind that arrives at the fire-retardant fabrics on the last fire-stopping suspension apparatus 100 suspended from the helicopter has been weakened considerably, as indicated by the thin, dotted-line arrows. As such, the wind can be effectively blocked and the spread of burning fires can be stopped. Thereafter, the helicopters may drop water from suspended spray systems to help extinguish the fire. As such, the fire-stopping suspension apparatus 100 of the present invention can effectively stop the fire from spreading further.

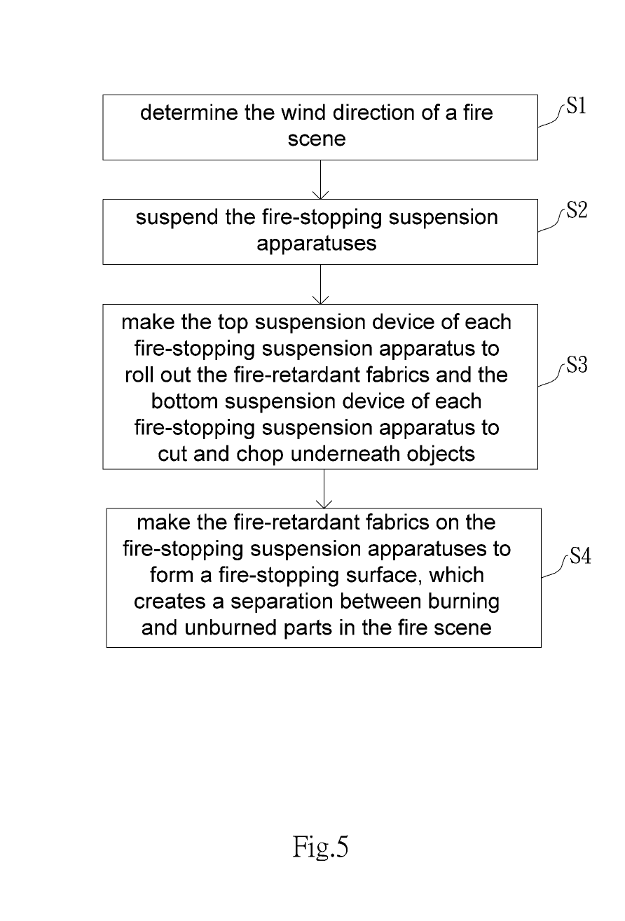

FIG. 5 is a flow chart showing a method of using the fire-stopping suspension apparatus of the present invention to stop the spread of fire. The method comprises the following steps. First, in step S1, determine the wind direction of a fire scene. Thereafter, in step S2, based on the scale of the fire scene, use multiple helicopters to suspend the fire-stopping suspension apparatuses respectively, whereby the fire-stopping suspension apparatuses are arranged in an upwind direction; the axial direction of each fire-stopping suspension apparatus and the wind direction form an acute angle; and a plurality of fire-stopping suspension apparatuses are suspended and arranged along the path of the wind. Thereafter, in step S3, make the top suspension device of each fire-stopping suspension apparatus to roll out the fire-retardant fabrics and the bottom suspension device of each fire-stopping suspension apparatus to cut and chop underneath objects. Finally, in step S4, make the fire-retardant fabrics on the fire-stopping suspension apparatuses to form a fire-stopping surface, which creates a separation between burning and unburned parts in the fire scene.

A fire-stopping suspension apparatus according to the present invention is intended to be suspended from a helicopter to reach a fire scene, and is arranged in an upwind direction depending on the wind direction in the fire scene. The bottom suspension device of the fire-stopping suspension apparatus can be used to cut and chop obstacles around or under it. Moreover, the fire-retardant fabrics on the top suspension device can be used to form a fire-stopping surface, which creates a separation between burning and unburned parts in the fire scene. As such, the fire-stopping suspension apparatus according to the present invention can effectively stop the spread of a forest fire.

What is claimed is:

1. A fire-stopping suspension apparatus, comprising:
a top suspension device comprising a first transmission mechanism, a plurality of shafts having fire-retardant fabrics thereon, and a top suspension support frame, wherein the shafts and the first transmission mechanism are mounted to the top suspension support frame; and the first transmission mechanism drives the shafts to roll out or roll back the fire-retardant fabrics; and
a bottom suspension device comprising a second transmission mechanism, a plurality of first cutter shafts, and a bottom suspension support frame, wherein the first cutter shafts and the second transmission mechanism are mounted to the bottom suspension support frame which is suspended at lower ends of the fire-retardant fabrics; and the second transmission mechanism drives the first cutter shafts so that objects under the bottom suspension device can be easily cut and chopped by the first cutter shafts.

2. The fire-stopping suspension apparatus of claim 1, further comprising at least one suspension arm on the top suspension support frame for hanging the fire-stopping suspension apparatus on a helicopter.

3. The fire-stopping suspension apparatus of claim 1, wherein the fire-retardant fabrics on every two adjacent shafts are arranged alternately to reduce wind speed.

4. The fire-stopping suspension apparatus of claim 1, wherein each fire-retardant fabric has at least two holes at opposite sides thereof, and a steel wire rope passes through each hole to connect the top suspension device and the bottom suspension device so as to hold the weight of the bottom suspension device.

5. The fire-stopping suspension apparatus of claim 1, wherein the bottom suspension device further comprises a plurality of third transmission mechanisms and a plurality of second cutter shafts; a pair of cutters is provided at two opposite sides of each second cutter shaft; the third transmission mechanisms, the second cutter shafts and the cutters are arranged at an outer edge of the bottom suspension support frame; and the third transmission mechanisms drive the second cutter shafts, which then cause the cutters to move accordingly, so that the cutters can easily cut and chop objects around the bottom suspension device.

6. The fire-stopping suspension apparatus of claim 5, wherein each of the cutters comprises a guide plate and a chain; the guide plate is secured to the outer edge of the bottom suspension support frame by means of a supporting portion; and the second cutter shaft is a sprocket whose teeth fit into and engage the chain.

7. The fire-stopping suspension apparatus of claim 5, wherein each third transmission mechanisms drives a corresponding second cutter shaft; every two adjacent second cutter shafts are arranged in a manner so that they do not align;
and each pair of cutters connected to the second cutter shaft does not align with another pair of cutters but overlaps with it.

8. A method of using the fire-stopping suspension apparatus of claim 1 to stop the spread of fire, comprising the following steps:
determining a wind direction of a fire scene;
based on the scale of the fire scene, suspending a plurality of fire-stopping suspension apparatuses respectively, wherein an axial direction of each fire-stopping suspension apparatus and the wind direction form an acute angle, and the plurality of fire-stopping suspension apparatuses are suspended and arranged along a path of the wind; and
making the top suspension device of each fire-stopping suspension apparatus to roll out the fire-retardant fabrics and the bottom suspension device of each fire-stopping suspension apparatus to cut and chop underneath objects; and
making the fire-retardant fabrics on the fire-stopping suspension apparatuses to form a fire-stopping surface, which creates a separation between burning and unburned parts in the fire scene.
